(19) United States
(12) Patent Application Publication
(10) Pub. No.: US 2010/0026874 A1
(43) Pub. Date: Feb. 4, 2010

(54) CCTV Camera Lens Adjustment Structure

(76) Inventor: Hai-Chin Chang, Wugu (TW)

Correspondence Address: SHUI-CHOU CHOU, 5032-12 Hunt Club Road, Wilmington, NC, 28403, US

(21) Appl. No.: 12/183,075

(22) Filed: Jul. 31, 2008

(51) Int. Cl. H04N 5/225

(52) U.S. Cl. 348/335; 348/E05.024

(57) ABSTRACT

The present invention relates to an improved CCTV camera lens adjustment structure comprising a housing with a shell and a cover, wherein the shell has a through hole; an image capturing unit installed in the shell, wherein one end is a lens corresponding to the hole installed on the shell; the lens is installed with a driving ring, said driving ring matches the fixed rod installed on the lens; said fixed rod is partially extended as driving ring; and a movable adjusting mechanism installed in the hole forming interference with fixed rod. Thus the matching of the shell and the adjustment structure is used for the image capturing unit to achieve the effect of ease in installation and waterproof, and the adjustment mechanism can be used to rotate the driving ring of the linked lens for rotating the lens of image capturing unit so as to achieve the convenience in use.

### FIELD OF THE INVENTION

The present invention relates to an improved CCTV camera lens adjustment structure, particularly a kind of image capturing unit for achieving ease in installation and waterproof effect and for the adjustment of focus of the lens from outside to achieve convenience in use.

### BACKGROUND OF THE INVENTION

Traditionally the CCTV camera consists of at least a housing and an image capturing unit installed in the housing, wherein the image capturing unit comprises a lens corresponding to one side of the housing and the housing is made of metallic material, its bottom has an opening corresponding to the outer edge of the bottom of the lens, and the opening is installed with a cover matching several fixing parts; thus it constitutes a lens installed in a desired location for the capturing of image concerned. When the focus of the lens is required for adjustment, the cover at the bottom of the shell can be removed and the hand could reach inside through the opening so that the hand could rotate the lens to achieve the adjustment of focus of the lens.

Although above mentioned traditional CCTV camera could achieve the effect of image capture and adjustment of the required focus, it is necessary to remove each fixing part one by one in order to remove the cover installed at the opening at the bottom of the housing for the adjustment of the focus of the lens of the CCTV camera. After removal of the cover, the hand could pass through the opening for the intended adjustment and after the adjustment all fixing parts could be returned through the opening together with the cover. Hence leading to the complexity in adjustment procedure and assembly work, resulting in inconvenience during adjustment. And as the diameter of the opening is often quite small, usually only the thumb and index finger are allowed to pass through the opening. Some openings even could only allow the index finger to pass through. Thus not only resulting in difficulty during adjustment but also worrying in cutting fingers due to the sharp edges formed by the material in the opening for the housing. Again, as there is an opening installed on the housing and the CCTV camera is usually installed outdoors, rain tends to enter the housing through the opening during rainy days, resulting in the damage to the image capturing unit.

### SUMMARY OF THE INVENTION

The main purpose of the present invention is to make use of the matching between housing and adjustment mechanism to enable imaging capturing unit with ease in installation and waterproof effect and to make use of the adjustment mechanism to rotate the driving ring of the linking lens so as to rotate the lens of image capturing lens outside the housing in order to achieve the convenience in use.

To achieve the above stated purpose, the present invention is regarding the improvement of adjustment mechanism for the lens of a CCTV camera comprising a housing having a shell and a cover, wherein the shell side of the cover has a through hole; an image capturing unit installed in the housing, wherein one end has a lens corresponding to the through hole on the cover, the lens is installed with a driving ring, the driving ring is installed on the lens to match with the fixing rod, and the fixing rod partially extends out the driving ring; and an adjustment mechanism installed in the through hole forms an interfering adjustment mechanism with fixed rod.

### BRIEF DESCRIPTION OF THE DRAWINGS

FIG. 1 is the perspective outlook of the present invention.

FIG. 2 is the exploded perspective illustration of the present invention.

FIG. 3 is the exploded illustration of the adjustment mechanism of the present invention.

FIG. 4 is the illustration of the using state of the present invention.

FIG. 5 is the cross-sectional state illustration of the present invention.

### DETAILED DESCRIPTION OF THE PREFERRED EMBODIMENTS

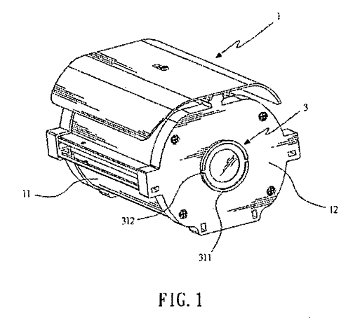

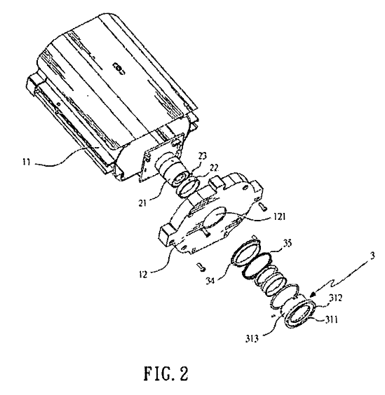

Please refer to the diagrams shown in FIGS. 1, 2, and 3 which are the illustration of the outlook of the present invention, the exploded diagram of the present invention, and the exploded diagram of the adjustment mechanism of the present invention. As shown in these diagrams, the present invention is an improved adjustment mechanism of the lens of the CCTV camera consisting of at least a housing 1, an image capturing unit 2, and an adjustment mechanism 3.

The housing 1 mentioned above contains at least a shell 11 and a cover 12 installed on the side of the shell 11 and with a through hole 121.

The said image capturing unit 2 is installed in the shell 11 mentioned above wherein one end has a lens 21 corresponding to the through hole 121 installed in the cover 12; the said lens 21 is installed with a driving ring 22; the said driving ring 22 is fixed on the lens 21 by matching the fixed rod 23; and the said fixed rod 23 partially extends out the driving ring 22 and said lens 21 depending on the requirement can be variable focal lenses, fixed lenses, or zoom lenses.

An adjustment mechanism 3 contains a base 31 wherein its one end is installed with a protruding ring 311 corresponding to two recesses 312; the said protruding ring 311 is pressed against on one side of the cover 12; the other side of the base 31 extends out with a movable sleeve 313 installed in the through hole 121 of the cover 12; the said sleeve 313 has a hollow section 314 linking to one end of the base 31, and the said sleeve 313 has an outer thread section 315, and the edge of one end of the said sleeve 313 forms a groove 316 with the fixed rod 23; a lens 32 is installed in the hollow section 314 of the sleeve 313 and pressed on the inside of the base 31; a ring 33 is installed in the sleeve 313 and limits the position of the lens 32 by matching with a fixed part 331; a fixed ring 34 has an inner thread section 341 and screwed on the outer side of the sleeve 313 and pressed against the other side of the cover 12, wherein between the said fixed ring 34 and the cover 12 is installed with an elastic part 35 slotting on the sleeve 313, and between the cover 12 and the protruding ring 311 of base 31 has a first gasket 317, and between the said lens 32 and the inside of the sleeve 313 has a second gasket 321. Thus, a brand-new improved CCTV camera lens adjustment mechanism is formed through the above stated structure. And as the said image capturing unit 2 is installed behind the housing 1 for sealing adjustment mechanism with a cover (without exposed opening); therefore, the image capturing unit 2 can achieve the effect of ease in installation and waterproof.

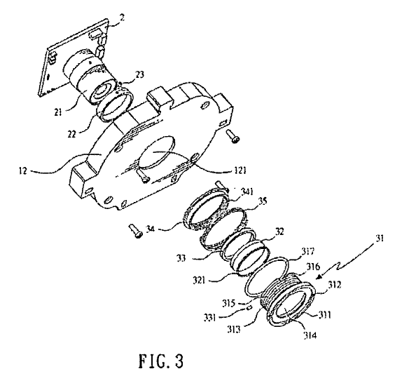

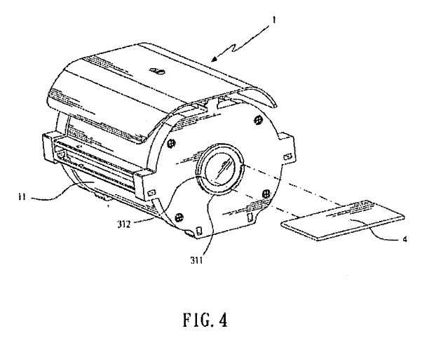

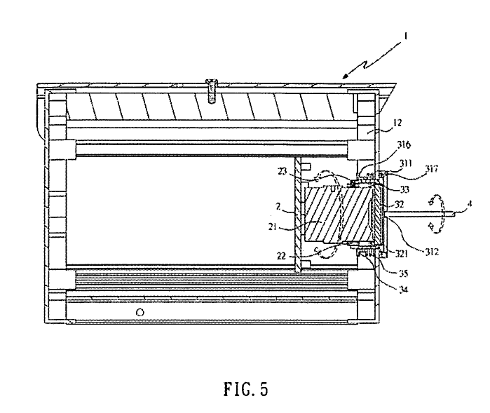

Please refer to the FIGS. 4 and 5, which shows the state of use of the present invention and the cross-sectional illustration of the present invention. As shown in the diagrams, when the present invention is being adjusted (please refer to the FIG. 3 at the same time) a tool 4 in the shape of a plate is used for adjustment mechanism 3, and one end of the said tool 4 is embedded in the corresponding two recesses 312 installed in the protruding ring 311 of the base 31, subsequently rotates in clockwise or counterclockwise directions depending on the need so that the sleeve 313 of said base 31 uses its outer thread section 315 to rotate in the inner thread section 341 of the fixed ring 34 and allowing the groove 316 of the said sleeve 313 to carry the fixed rod 23 of the extended driving ring 22. As the said driving ring 22 is matched to the fixed rod 23 and fixed onto the lens 21, when the fixed rod 23 is carried together the driving ring 22 is linked along, allowing the lens 21 to rotate so that the lens 21 of the image capturing unit 2 also rotates. Thus, the focus of the lens 21 can be adjusted on the outer section in order to achieve the convenience when in use.

In summary, the improved CCTV camera lens adjustment structure of the present invention could overcome all drawbacks of the traditional monitor. Through the matching of the housing and the adjustment mechanism the image capturing unit could achieve the effect of ease in installation and waterproof, and the adjustment mechanism can be used to carry along the driving ring on the lens and rotates the lens of the image capturing unit and adjust the focus of the lens on the outside to achieve the convenience in use, and further to enable the present invention to meet the requirement of user in more advanced, more practical application. This indeed meets the requirement of patent application for the invention and I hereby apply for the patent application.

However, the above is only for the description of the present invention and by no means limit to the range of embodiment of the present invention. All simple equivalent changes and modifications created according to the description of the patent application range and the description of the present invention shall all be covered in the patent of the present invention.

What is claimed is:

1. An improved CCTV camera lens adjustment structure comprising:
A housing, which has at least a shell, and a cover installed at the end of the shell and with a through hole;
An image capturing unit installed in the shell described above, wherein one end has a lens corresponding to the through hole installed in the cover, said lens is installed with a driving ring, the said driving ring is for matching with the fixed rod installed on the lens, and the said fixed rod is partially extended out of the driving ring; and
An adjustment mechanism, which is installed and moving in the through hole of the cover, forms interference with the fixed rod.

2. An improved CCTV camera lens adjustment structure as claimed in claim 1, wherein said lens can be variable focal lenses, fixed lenses, or zoom lenses.

3. An improved CCTV camera lens adjustment structure as claimed in claim 1, wherein said adjustment mechanism comprises:
A base, one end of which is installed with protruding ring with two corresponding recesses; said protruding ring is pressed against one side of the cover; the other end extends with a movable sleeve installed in the through hole of the cover; said sleeve has a hollow section linking to one end of the base, and said sleeve has an outer thread section, and the edge of one end of the said sleeve forms a groove with the fixed rod;
A lens installed in the hollow section of the sleeve presses against inside of the base;
A ring installed in the sleeve limits the position of the lens by matching a fixed part;
A fixed ring having an inner thread section and screwed on the outside of the sleeve presses against the other side of the cover.

4. An improved CCTV camera lens adjustment structure as claimed in claim 3, wherein an elastic part is slotted between said fixed ring and the cover.

5. An improved CCTV camera lens adjustment structure as claimed in claim 3, wherein a first gasket is installed between the cover and the protruding ring of the base.

6. An improved CCTV camera lens adjustment structure as claimed in claim 3, wherein a second gasket is installed between said lens and the inside of the sleeve.
